(19) United States
(12) Patent Application Publication
(10) Pub. No.: US 2010/0043065 A1
(43) Pub. Date: Feb. 18, 2010

(54) SINGLE SIGN-ON FOR WEB APPLICATIONS

(75) Inventors: Gavin G. Bray, Robina (AU); Parley A. Salmon, Raleigh, NC (US); Peter J. K. Tuton, Shailer Park (AU); Patrick R. Wardrop, Austin, TX (US)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/189,975

(22) Filed: Aug. 12, 2008

(51) Int. Cl. H04L 9/32; G06F 3/048

(52) U.S. Cl. 726/8; 715/764

(57) ABSTRACT

Techniques for providing identity and other attributes to sign-on web applications in configurable application specific formats are described herein. In some embodiments, a method for allowing access to a plurality of target applications after single sign-on includes detecting, after the single sign-on, a request to access a target application of the plurality of target applications, the request including a federated single sign-on (FSSO) attributes cookie. The method can also comprise determining user attributes from the FSSO attributes cookie and determining a configuration associated with the target application, wherein the configuration indicates a format for one or more of the user attributes, and wherein the format is associated with the target application. The method can also include creating a data structure according to the configuration, wherein the data structure includes one or more of the user attributes arranged in the format and providing the data structure to the target application.

### BACKGROUND

1. Technical Field

Embodiments of the inventive subject matter generally relate to the field of computer networks and security, and more particularly, to methods for providing identity and other attributes to sign-on web applications in configurable application specific formats.

2. Background

User authentication is a feature that websites provide to ensure that users accessing the website's resources are valid users and not imposters. Websites hosting resources (e.g., applications) generally ask for a user's username and password to prove identity before authorizing access to the resources. Single sign-on (SSO) is an access control mechanism which enables users to authenticate once (e.g., provide a username and password) and gain access to software (e.g., Internet) resources across multiple systems. Typically, an SSO system enables user access to resources within an enterprise or an organization. Federated Single Sign-on (F-SSO) extends the concept of single sign-on across multiple enterprises thus establishing partnerships between different organizations and enterprises.

### SUMMARY

Techniques for providing identity and other attributes to sign-on web applications in configurable application specific formats are described herein. In some embodiments, a method for allowing access to a plurality of target applications after single sign-on includes detecting, after the single sign-on, a request to access a target application of the plurality of target applications, the request including a federated single sign-on (FSSO) attributes cookie. The method can also comprise determining user attributes from the FSSO attributes cookie and determining a configuration associated with the target application, wherein the configuration indicates a format for one or more of the user attributes, and wherein the format is associated with the target application. The method can also include creating a data structure according to the configuration, wherein the data structure includes one or more of the user attributes arranged in the format and providing the data structure to the target application.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating the flow of operations in typical federated single sign-on (FSSO) process.

FIG. 2 is a block diagram illustrating a client-server system configured to ensure trustworthiness of user credentials in a federated single sign-on system and to present user attributes to F-SSO applications in a specified format, according to some embodiments of the invention.

FIG. 3 is a flow diagram illustrating operations for determining user attributes from an F-SSO attributes token and converting the information into a format required by the target application, according to some embodiments of the invention.

FIG. 4 illustrates the sequence of operations in an F-SSO process after the integration of an F-SSO adapter, according to some embodiments of the invention.

FIG. 5 shows an example of an F-SSO adapter processing an incoming request, modifying, and forwarding the modified request to a target application, according to some embodiments of the invention.

FIG. 6 is a block diagram illustrating a system configured to present user attributes to F-SSO applications in a specified format, according to some embodiments of the invention.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. In some instances, well-known instruction instances, protocols, structures, and techniques have not been shown in detail in order not to obfuscate the description.

### Introduction

User authentication is one function that service providers offer to ensure that users accessing resources (e.g., applications, web content, etc.) are authorized to do so. To ensure that a user is not an imposter, service providers (e.g., web servers) generally ask for a user's username and password to prove identity before authorizing access to resources. Single sign-on (SSO) is an access control mechanism which enables a user to authenticate once (e.g., provide a username and password) and gain access to software resources across multiple systems. Typically, an SSO system enables user access to resources within an enterprise or an organization. Federated Single Sign-on (F-SSO) extends the concept of single sign-on across multiple enterprises, thus establishing partnerships between different organizations and enterprises. F-SSO systems typically include protocols that allow one enterprise (e.g., an identity provider) to supply a user's identity and other attributes to another enterprise (e.g., a service provider). In other words, an F-SSO system helps transport the user's credentials from the identity provider to the service provider using any suitable protocol.

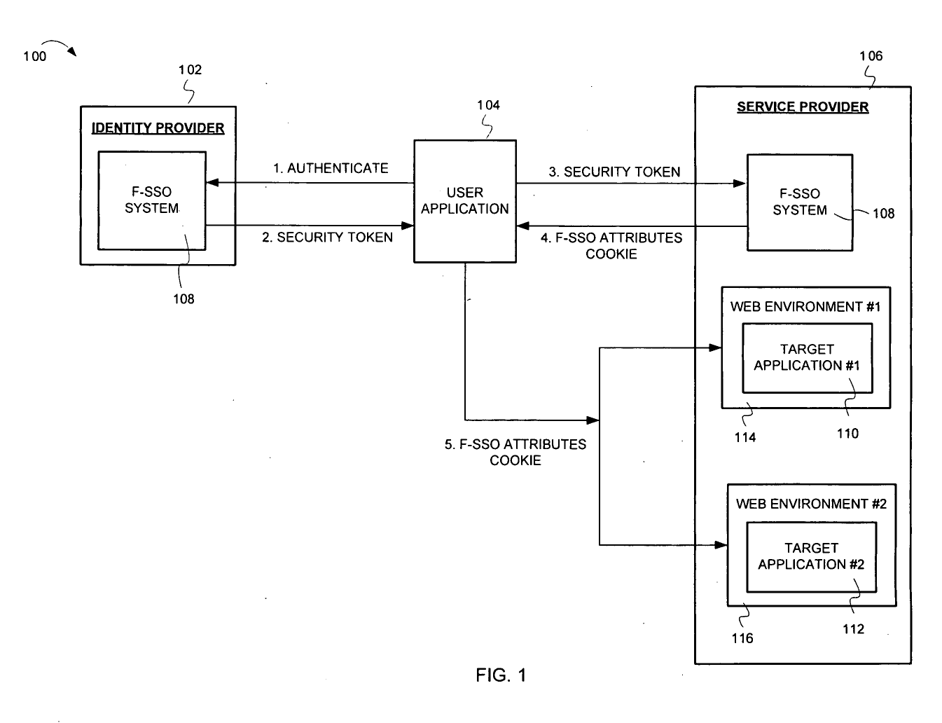

FIG. 1 is a block diagram illustrating the flow of operations in a federated single sign-on (F-SSO) process. As shown in FIG. 1, the F-SSO process 100 involves communications between an identity provider 102, a user application 104, and a service provider 106. The identity provider 102 and the service provider 104 include an F-SSO system 108, which includes logic to authenticate a user, establish the user's credentials, and generate an encrypted security token (e.g., cookie) including user information. Additionally, the service provider 106 can also include one or more target applications 110 & 112. The target applications can reside within the same web environment or be a part of different web environments 114 & 116 (e.g., Apache, WebSphere®, etc.) within the same service provider 106. The user application 104 can include logic (e.g., web browsers) to present content (e.g., web pages) to the user.

In some embodiments, the user application 104 first authenticates to the identity provider 102 (e.g., providing a username and password) as indicated by step 1. In step 2, the identity provider's F-SSO system 108 returns a security token to the user. This security token may be time-sensitive (e.g., can include a time stamp) and cryptographically signed. The security token can include the user's identity (e.g., username) and other attributes (e.g., user identification number) that the identity provider 102 wishes to provide to the service provider 106. The user application 104 can present the security token to the service provider's F-SSO system using any suitable technique (e.g., HTTP request) and message structure (e.g., using HTTP query strings, HTTP POST data, etc.) defined by the F-SSO protocol (refer to step 3). In step 4, the service provider's F-SSO system 108 can validate the cryptographic signature of the security token to confirm the token's authenticity of origin and that the contents of the security token are trustworthy. The service provider's F-SSO system can also extract the user's identity and related attributes from the security token and generate an F-SSO attributes cookie including the user's identity and attributes.

After achieving single sign-on (i.e., conveying user attributes from the identity provider's F-SSO system to the service provider's F-SSO system), if the user wants to access a target application (e.g., 110) hosted by the service provider 106, the user application 104 must pass the F-SSO attributes cookie obtained from the service provider's F-SSO system 108 to the target application (refer to step 5). This transfer of user attributes (e.g., in an F-SSO cookie) should also be done in a trustworthy and secure manner and can be performed on the basis of F-SSO prescribed protocols (e.g., HTTP can be used to transport protocol messages, where the user's browser also supports HTTP). If the data contained within an F-SSO attributes cookie is accepted and understood by the target application (e.g., if the target application can decrypt and retrieve the cookie's contents), the target application (e.g., 110) can validate and create a session for the user. In some embodiments, the target applications (e.g., 110) understand the F-SSO attributes cookie or they can be part of the F-SSO process (i.e., the target application may not include an F-SSO system).

As shown, each target application can be located in a different web environment, with different authentication mechanisms and different requirements. For example, target application 1 may be part of an Apache web server, while target application 2 can be a part of an IBM WebSphere® environment. In some embodiments, the service provider's F-SSO system 108 can provide a mechanism to transfer the contents of the security token and other local attributes to applications within the service provider's environment.

Some embodiments include a system, which translates F-SSO attributes cookie information into formats understandable by applications. Some embodiments of the inventive subject matter describe an F-SSO system component which can be integrated into F-SSO processes (without modifying the process) to provide user attributes to applications, which are a part of the federated single sign-on process, in the application specified format. The following discussion describes this and other important features of the invention in greater detail.

### Example Architecture and Operating Environment

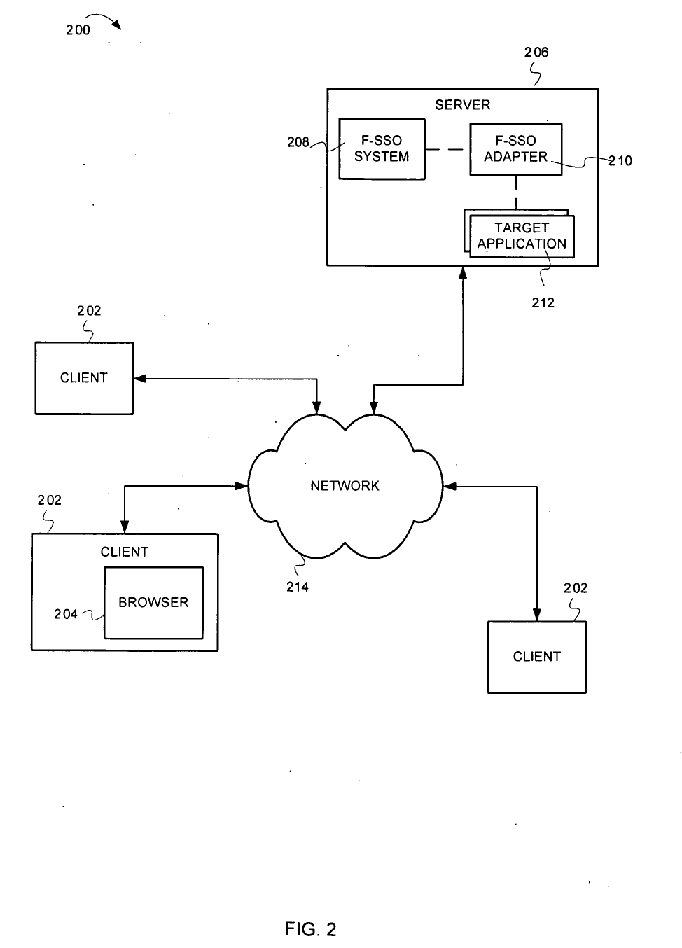

FIG. 2 is a block diagram illustrating a client-server system configured to ensure trustworthiness of user credentials in a federated single sign-on system and to present user attributes to F-SSO applications in a specified format, according to some embodiments of the invention. As shown in FIG. 2, the system 200 includes a server 206 and clients 202. The server 206 includes an F-SSO system 208, an F-SSO adapter 210, and one or more target applications 212. The F-SSO system 208 includes logic (e.g., web browser 204, target application 212, etc.) to process and present to a user an encrypted and time sensitive F-SSO cookie including user information (e.g., user name, user id, etc). The F-SSO adapter 210 includes logic to intercept and retrieve user information from the F-SSO cookie, verify the authenticity of the information, and convert the cookie's information into a format that is understandable by each of the target applications 212.

In some embodiments, the F-SSO adapter 210 receives from a user an F-SSO attributes cookie, which was created by an F-SSO system. The F-SSO adapter 210 can decrypt the cookie and retrieve the contents of the cookie (e.g., username, user id, and other user attributes). The F-SSO adapter 210 can determine the header configuration of the target application 212, which in some instances is stored as part of the adapter, strip the old header, and create a new header with labels and data compatible with the target application 212. The F-SSO adapter 210 can then send this header along with other data (e.g., F-SSO attributes cookie) to the target application 212 on behalf of the user application (e.g., web browser). In some instances, the target application 212 can be a part of different web environments. In some instances, the target application 212 may also reside on a server separate from the F-SSO system 208 and F-SSO adapter 210. In some embodiments, the target application's configurations are stored as part of the adapter; while in other instances, the adapter may interface with a cache (not shown) either on the server or in external memory to store or determine user information. The cache may be used to reduce the cost of decrypting the cookie and converting it into the format expected by the target application.

The server 208 and clients 202 are connected through a communication network 214. The communication network 214 can include any technology suitable for passing communication between the clients and server (e.g., Ethernet, 802.11n, SONET, etc.). Moreover, the communication network 214 can be part of other networks, such as cellular telephone networks, public-switched telephone networks, cable television networks, etc. In some embodiments, the server 208 and clients 202 can be any suitable computing devices capable of executing software in accordance with the embodiments described herein.

### Example F-SSO Adapter Operations

This section describes operations associated with some embodiments of the invention. The flow diagrams will be described with reference to the architectural block diagram presented above. However, in some embodiments, the operations can be performed by logic not described in the block diagrams; furthermore, some embodiments can perform more or less than the operations shown in any flow diagram. In certain embodiments, the operations can be performed by executing instructions residing on machine-readable media (e.g., software), while in other embodiments, the operations can be performed by hardware and/or other components (e.g., firmware). In some embodiments, the operations can be performed in series, while in other embodiments, one or more of the operations can be performed in parallel.

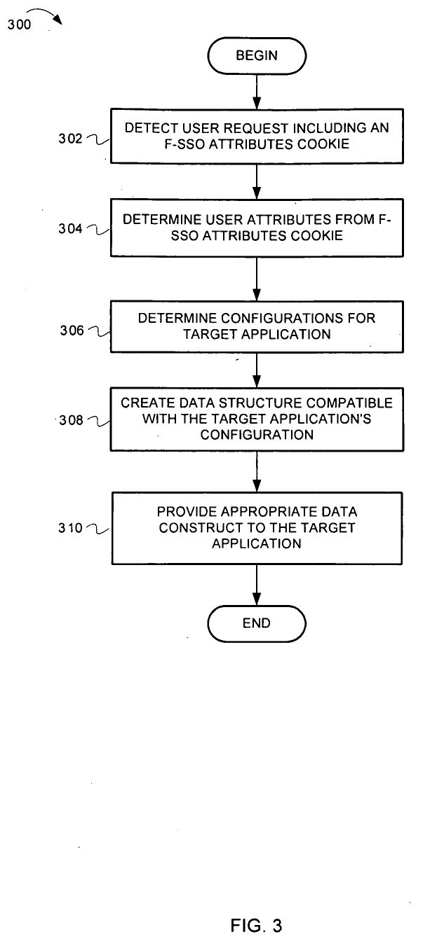

FIG. 3 is a flow diagram illustrating operations for determining user attributes from an F-SSO attributes token and converting the information into a format required by the target application, according to some embodiments of the invention. The following discussion will describe the flow 300 with reference to the system of FIG. 2. The flow diagram 300 begins at block 302.

At block 302, the F-SSO adapter 210 detects a user request including a federated single sign-on (F-SSO) token. In some instances, the request may originate from a user application (e.g., a browser 204) and may indicate a destination (e.g., target application 212). The token can be a cookie including F-SSO attributes. The flow continues at block 304.

At block 304, the F-SSO adapter 210 determines the user's attributes from the F-SSO cookie. The F-SSO adapter 210 can include logic (e.g., instructions executable by a machine, circuits, etc.) to decrypt the F-SSO attributes cookie and retrieve the information contained within the cookie. In some instances, the F-SSO adapter 210 can also store the contents of the cookie in a temporary cache (not shown) for the duration of the session. The F-SSO attributes cookie can include a timestamp (to ensure validity of data) and user attributes including username, user id, user email address, user application's IP address, etc. The flow continues at block 306.

At block 306, the F-SSO adapter 210 determines the configuration of the target application. Every target application 212 serviced by the F-SSO adapter 210 can be associated with a configuration file which may be stored as part of the F-SSO adapter 210 or stored separately from the adapter. In some instances, the configuration file can be an XML file and can include information describing the mapping of F-SSO details (retrieved from the F-SSO attributes cookie at block 304) into a format that is understandable by the target application 212. In other instances, the configuration file can also be stored in YAML, JSON, INI, or Apache file formats. The flow continues at block 308.

At block 308, the F-SSO adapter 210 creates a data structure including user credentials, where the data structure is compatible with the target application's configuration. For example, when a browser accesses web applications, it transmits data (content and format of information as seen on the web page) and control information. Either the browser 204 or the target application 212 can interpret the control information (e.g., timestamps, IP address, etc.). Different target applications 212 accept this control information in a variety of methods. Thus, user credentials can be passed from the web server to the web application by embedding them in data constructs such as HTTP headers, server variables, cookies, environment variables, etc. For example, one target application may be designed to receive user information through an HTTP header, while another target application may be designed to receive user credentials via server variables. Thus, the F-SSO adapter 210 helps provide support for different web environments, and different methods by which applications can receive user credentials. This enables applications to participate in the F-SSO process without any modifications to the application itself. The flow continues at block 310.

At block 310, the F-SSO adapter 210 provides the appropriate data construct to the target application 212. If the content in data construct (e.g., HTTP header, server variable, etc.) meets the application's information request, the user is validated and the application creates a session for the specified user, allowing the user to access the system's resources and/or the application. In some instances, if the incoming request does not include an F-SSO attributes cookie or if the outgoing data construct does not include any user information, the application can present a login screen asking for the user's credentials, block the user's access to the system, etc. After the F-SSO adapter 210 forwards the modified data construct to the target application 212, the flow ends.

Thus, the F-SSO adapter 210 offers configuration and processing, including the use of an encrypted security token within the F-SSO cookie which allows for privacy and verification of origin (i.e., to ensure that an F-SSO cookie originated from an authentic F-SSO system). Additionally, the F-SSO adapter can configure data constructs (e.g., HTTP headers, server variables, etc.) with user information to meet the needs of different target applications.

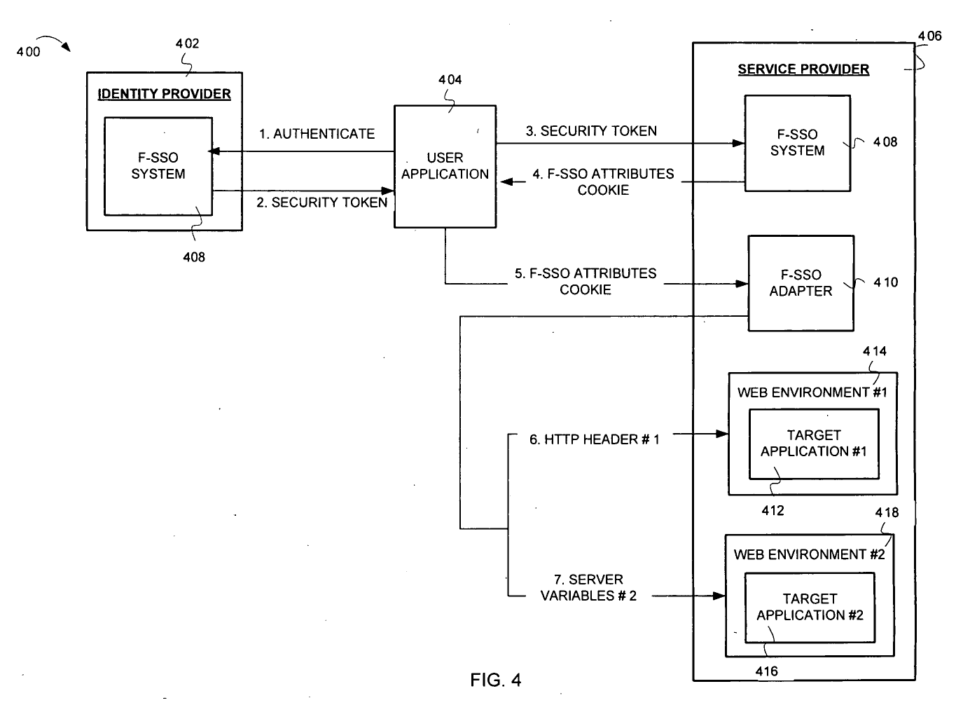

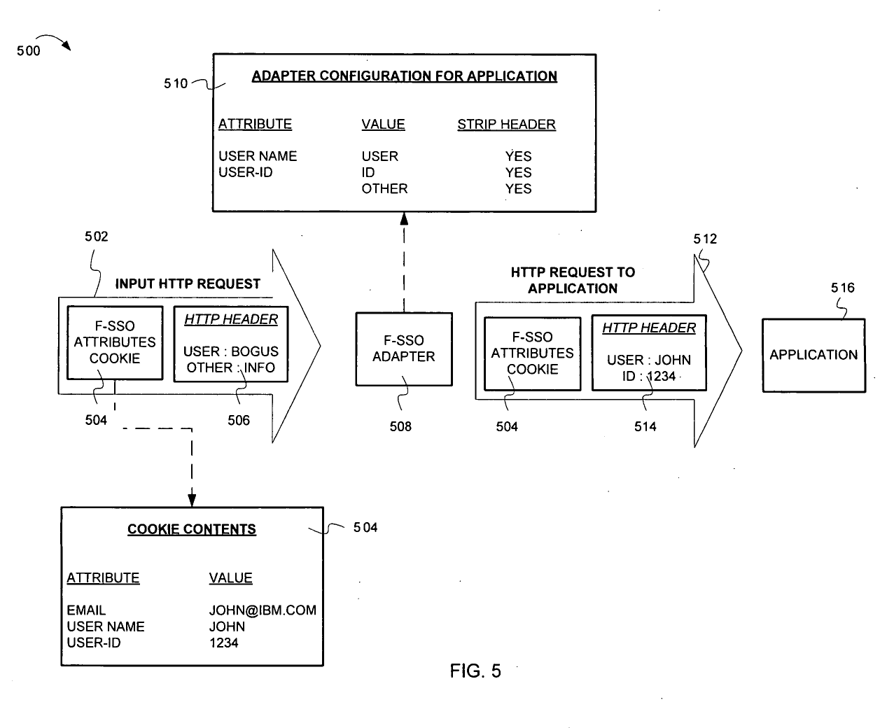

FIG. 4 illustrates a sequence of operations in an F-SSO process after the integration of an F-SSO adapter, according to some embodiments of the invention. In FIG. 4, steps 1 though 4 indicate the process of authentication at the identity provider 402 and generation of an F-SSO attributes cookie at the service provider 406. As illustrated in step 5, an F-SSO adapter 410 may intercept the user application's (404) request, access the F-SSO attributes cookie, decrypt and verify the contents of the cookie (e.g., using the security token within the cookie), and retrieve the user attributes stored within the F-SSO attributes cookie. The F-SSO adapter 410 can then map each user attribute to a data construct based on the target application's requirements. The concept of generating application-specific data constructs is further illustrated in FIG. 5. In step 6, the F-SSO adapter 410 maps the user attributes to one or more HTTP headers and transmits these headers to target application 1 (412). Similarly, in step 7, the F-SSO adapter 410 maps the user attributes to server variables for target application 2 (416).

### F-SSO Adapter Operations—An Example

FIG. 5 shows an example of an F-SSO adapter processing an incoming request, and modifying and forwarding the request to a target application, according to some embodiments of the invention. As shown in the Figure, a user request 502 to a target application 516 is intercepted by an F-SSO adapter 508. The user request is in the form of an input HTTP request, which includes an F-SSO attributes cookie 504 and an HTTP header 506. The F-SSO attributes cookie 504 is acquired from the service provider's F-SSO system. The FSSO attributes cookie can include user attributes (e.g., email address, user name, user id, etc.) in an encrypted format. The HTTP header 506 can include control information (e.g., such as user credentials, source application information, etc.) sent from the user application (e.g., browser).

Block 510 illustrates an example configuration file for a target application 516 used by the F-SSO adapter 508. The first column in the adapter configuration represents the F-SSO attributes, which are embedded in the F-SSO attributes cookie 504 (end result of F-SSO system process). In other words, column 1 represents the data label of the user attributes created by the F-SSO system cookie 504. The second column corresponds to the name of the header that the target application understands and expects to receive. For example, the specified target application 516 will recognize headers with the name “User”, “Id”, and “Other” as valid headers. In other words, the second column represents the data label that is understood by the target application. The third column (“Strip Header”) indicates whether the incoming headers must be stripped before creating new headers for the incoming data. Thus, the target application never receives header information that was stripped from the incoming request.

In some embodiments, the F-SSO adapter 508 intercepts the input HTTP request 502 and looks up the application's adapter configuration 510. The F-SSO adapter 508 decrypts the F-SSO attributes cookie 504, retrieves the contents of the cookie, and strips the headers 506 based on the adapter configuration 510. In FIG. 5, the F-SSO adapter 508 also creates two headers (based on the target application's configuration file 510) “User” and “Id” and sets their values based on the contents of the F-SSO attributes cookie (i.e., “John” and “1234” respectively). Since the configuration for the target application does not list “email”, the F-SSO adapter 508 does not process the “email” attribute. The F-SSO adapter 508 can create an outgoing HTTP request 512, with the F-SSO attributes cookie 504 and the modified HTTP header 514, and transmit the request to the target application 516.

In other embodiments, the F-SSO adapter 508 can also prevent a system attack. As shown in FIG. 5, the input HTTP request 502 (coming from the user or browser) includes a “User” header with a value “Bogus”. This can represent a potential attack on the system. For example, this attack could be a result of an unauthorized user trying to break into the application, users who did not go though the single sign-on process trying to provide their own credentials and hack into the system, etc. Through the adapter configuration file 510, programmers can specify whether a particular header should be stripped from the incoming header. By removing the data construct, if it already exists in the input request, the F-SSO adapter 508 can ensure that the data construct presented to the target application 516 can only have originated from the service provider's F-SSO and hence is trustworthy. The F-SSO adapter 508 can look up the configuration for the target application, determine that the incoming headers with header names “User” and “Other” must be stripped, and remove the headers from the incoming request. Because an unauthorized user could write a script or modify the browser to present invalid or bogus credentials, the FSSO adapter 508 removes all the user information (i.e., the invalid credentials) from the incoming headers. In some embodiments, a bogus input request will not include an F-SSO attributes cookie with user information (validated by the FSSO system); therefore, the outgoing request 512 to the target application 516 will not include header information. In other words, the outgoing header 514 will include a header name but no user credentials to facilitate a login. On receiving an empty header from the F-SSO adapter 508, the target application 516 can take the necessary action by denying access to the user, presenting a login screen, etc. Without an F-SSO adapter 508, the bogus header information would be communicated to the target application, where the application would assume that the credentials are trustworthy, and grant system access to the unauthorized user. Thus, incorporating an F-SSO adapter 508 in the F-SSO system also prevents users from hacking into the system and guarantees that all information from adapter to the application is reliable and trustworthy.

### Example Server Architecture

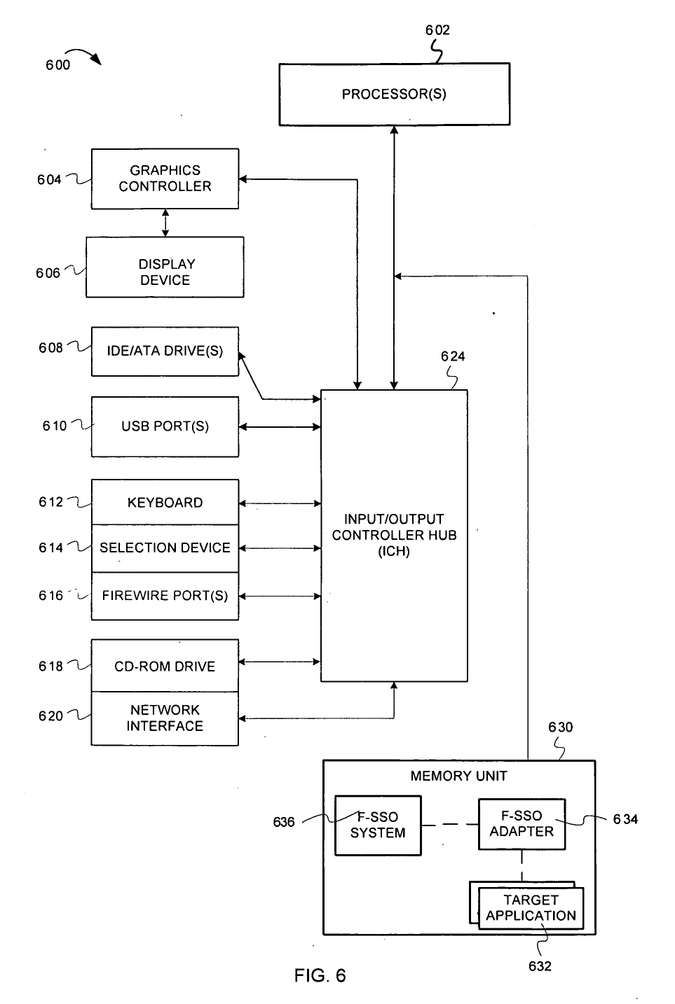

FIG. 6 is a block diagram illustrating a system configured to present user attributes to F-SSO applications in a specified format, according to some embodiments of the invention. The computer system 600 includes a processor 602. The processor 602 is connected to an input/output controller hub 624 (ICH), also known as a south bridge. A memory unit 630 interfaces with the processor 602 and the ICH 624. The main memory unit 630 can include any suitable random access memory (RAM), such as static RAM, dynamic RAM, synchronous dynamic RAM, extended data output RAM, etc.

In one embodiment, the memory unit 630 includes an F-SSO system 636, an F-SSO adapter 634, and one or more target applications 632. The F-SSO system 636 includes logic to present, to a user (e.g., web browser, target application 632, etc.) an encrypted and time sensitive F-SSO cookie including user information (e.g., user name, user id, etc). The F-SSO adapter 634 includes logic to decrypt and retrieve user information (e.g., username, user id, etc.) from the F-SSO attributes cookie. The F-SSO adapter 634 can also verify the authenticity of the information, strip the old header, create a new header with labels and data based on the adapter's configuration for the target application 632, and convert the cookie's information into a format that is understandable by the target applications.

The ICH 624 connects and controls peripheral devices. In FIG. 6, the ICH 624 is connected to IDE/ATA drives 608 (used to connect external storage devices) and to universal serial bus (USB) ports 610. The ICH 624 may also be connected to a keyboard 612, a selection device 614, firewire ports 616 (for use with video equipment), CD-ROM drive 618, and a network interface 620. The ICH 624 can also be connected to a graphics controller 604. The graphics controller is connected to a display device (e.g., monitor).

Embodiments of the inventive subject matter can be implemented in any web server environment supporting the inclusion of custom software that can receive and alter HTTP web requests prior to their delivery to the target applications. This includes, but is not limited to, a Microsoft Internet Server Application Program Interface (ISAPI) filter that is configured against a Microsoft Internet Information Services (IIS) web server. It could also be implemented as an Apache web server module. Both the ISAPI filter and Apache module correspond to the generic term, adapter, referred to in the previous paragraphs.

In some embodiments, the computer system 600 can include additional devices and/or more than one of each component shown in FIG. 6 (e.g., video cards, audio cards, peripheral devices, etc.). For example, in some instances, the computer system 600 may include multiple processors, multiple cores, multiple external CPU's. In other instances, components may be integrated or subdivided

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

### Conclusion

While the embodiments are described with reference to various implementations and exploitations, it will be understood that these embodiments are illustrative and that the scope of the inventive subject matter is not limited to them. In general, techniques for providing identity and other attributes to sign-on web applications in configurable application specific formats are described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for allowing access to a plurality of target applications after a single sign-on, the method comprising:
detecting, after the single sign-on, a request to access a target application of the plurality of target applications, the request including a federated single sign-on (FSSO) attributes cookie;
determining user attributes from the FSSO attributes cookie;
determining, based on the FSSO attributes cookie, a configuration associated with the target application, wherein the configuration indicates a format for one or more of the user attributes, and wherein the format is associated with the target application;
creating a data structure according to the configuration, wherein the data structure includes one or more of the user attributes arranged in the format; and
providing the data structure to the target application.

2. The method of claim 1, wherein the providing the data structure to the target application further includes:
stripping hypertext transport protocol headers from the request; and
creating new headers, wherein the new headers include the data structure.

3. The method of claim 1, wherein the user attributes are included in the FSSO attributes cookie, and wherein the user attributes include one or more of username, user id, password, email address, and source application internet protocol (IP) address.

4. The method of claim 1 further comprising:
determining another configuration associated with another target application, wherein the other configuration indicates another format for one or more of the user attributes, and wherein the other format is associated with the other target application;
creating another data structure according to the other configuration, wherein the other data structure includes one or more of the user attributes arranged in the other format; and
providing the other data structure to the other target application.

5. The method of claim 1, wherein the configuration resides in an extensible markup language (XML) file.

6. The method of claim 1, wherein before provision to the target application, the data structure is embedded in one or more of hypertext transfer protocol headers, server variables, cookies, and environment variables.

7. The method of claim 1 further comprising:
detecting an absence of the FSSO attributes cookie;
requesting additional user attributes through a graphical user interface.

8. A system configured to allow access to a plurality of target applications after a single sign-on, the apparatus comprising:
a service provider configured to host a plurality of target applications residing in one or more web environments;
a federated single sign-on (FSSO) system configured to authenticate a user, establish the user's credentials, and generate an FSSO attributes cookie,
an FSSO adapter configured to
detect, after the single sign-on, a request to access a target application of the plurality of target applications, the request including the federated single sign-on (FSSO) attributes cookie,
determine user attributes for the FSSO attributes cookie,
determine a configuration associated with the target application, wherein the configuration indicates a format for one or more of the user attributes, and wherein the format is associated with the target application,
create a data structure according to the configuration, wherein the data structure includes one or more of the user attributes arranged in the format, and
provide the data structure to the target application.

9. The system of claim 8, wherein the FSSO adapter is further configured to, for the provision of the data structure to the target application, strip hypertext transport protocol headers from the request, and create new headers, wherein the new headers include the data structure.

10. The system of claim 8, wherein the user attributes are included in the F-SSO attributes cookie, and wherein the user attributes include one or more of username, user id, password, email address, and source application internet protocol (IP) address.

11. The system of claim 8, wherein the FSSO adapter is further configured to:
determine another configuration associated with another target application, wherein the other configuration indicates another format for one or more of the user attributes, and wherein the other format is associated with the other target application,
create another data structure according to the other configuration, wherein the other data structure includes one or more of the user attributes arranged in the other format, and
provide the other data structure to the other target application.

12. The system of claim 8, wherein the configuration resides in an extensible markup language (XML) file.

13. The system of claim 8, wherein the FSSO adapter is configured to embed, before provision to the target application, the data structure in one or more of hypertext transfer protocol headers, server variables, cookies, and environment variables.

14. The system of claim 8 further comprising:
the target application configured to request additional user attributes through a graphical user interface.

15. One or more machine-readable media having stored therein a program product, which when executed, causes a set of one or more processor units to perform operations for allowing access to a plurality of target applications after a single sign-on, the operations comprising:
detecting, after the single sign-on, a request to access a target application of the plurality of target applications, the request including a federated single sign-on (FSSO) attributes cookie;
determining user attributes from the F-SSO attributes cookie;
determining a configuration associated with the target application, wherein the configuration indicates a format for one or more of the user attributes, and wherein the format is associated with the target application;
creating a data structure according to the configuration, wherein the data structure includes one or more of the user attributes arranged in the format; and
providing the data structure to the target application.

16. The one or more machine-readable media of claim 15, wherein the providing the data structure to the target application further includes:
stripping hypertext transport protocol headers from the request; and
creating new headers, wherein the new headers include the data structure.

17. The one or more machine-readable media of claim 15, wherein the user attributes are included in the F-SSO attributes cookie, and wherein the user attributes include one or more of username, user id, password, email address, and source application internet protocol (IP) address.

18. The one or more machine-readable media of claim 15, further comprising:
determining another configuration associated with another target application, wherein the other configuration indicates another format for one or more of the user attributes, and wherein the format is associated with the other target application;
creating another data structure according to the other configuration, wherein the other data structure includes one or more of the user attributes arranged in the other format; and
providing the other data structure to the other target application.

19. The one or more machine-readable media of claim 15, wherein the configuration resides in an extensible markup language (XML) file.

20. The one or more machine-readable media of claim 15, wherein before provision to the target application the data structure is embedded in one or more of hypertext transfer protocol headers, server variables, cookies, and environment variables.
